(19) United States
(12) Patent Application Publication
(10) Pub. No.: US 2021/0248425 A1
(43) Pub. Date: Aug. 12, 2021

(54) REINFORCED TEXT REPRESENTATION LEARNING

(71) Applicant: NEC Laboratories America, Inc., Princeton, NJ (US)

(72) Inventors: Bo Zong, West Windsor, NJ (US); Haifeng Chen, West Windsor, NJ (US); Lichen Wang, Maiden, MA (US)

(21) Appl. No.: 17/155,452

(22) Filed: Jan. 22, 2021

Related U.S. Application Data
(60) Provisional application No. 62/975,280, filed on Feb. 12, 2020.

(51) Int. Cl. G06K 9/62; G06N 3/08; G06F 40/30; G06N 5/00

(52) U.S. Cl. CPC G06K 9/6263; G06N 5/003; G06F 40/30; G06N 3/08

(57) ABSTRACT

A method for implementing graph-based reinforced text representation learning (GRTR) is presented. The method includes, in a training phase, generating a dependency tree for training text data, training a GRTR agent by learning to navigate in the dependency tree and selectively collecting semantic information, learning GRTR agents, and storing, in a GRTR-specific memory, parameters of the learned GRTR agents. The method further includes, in a testing phase, generating a dependency tree for testing the text data, retrieving and evaluating the learned GRTR agents of the training phase to evaluate testing samples, making task-specific decisions for the testing samples, and reporting the task-specific decisions to a computing device operated by a user.

### RELATED APPLICATION INFORMATION

This application claims priority to Provisional Application No. 62/975,280, filed on Feb. 12, 2020, the contents of which are incorporated herein by reference in their entirety.

### BACKGROUND

### Technical Field

The present invention relates to aspect-based sentiment classification and, more particularly, to reinforced text representation learning.

### Description of the Related Art

Aspect-based sentiment classification tasks aim to predict the sentiment categories or polarities of one or more aspects in a semantic description. It is a challenging task since different aspects could have significantly different sentiment polarities. Correct alignments of the aspects and sentiments are important. Attention strategy, convolutional neural networks, and sentence dependency trees are widely deployed for handling such challenges. However, these approaches cannot effectively pinpoint the most relevant sentiments, and long sentences which include a lot of irrelevant contextual words also increase the difficulties for judging the aspect sentiment.

### SUMMARY

A computer-implemented method for implementing graph-based reinforced text representation learning (GRTR) is presented. The method includes, in a training phase, generating a dependency tree for training text data, training a GRTR agent by learning to navigate in the dependency tree and selectively collecting semantic information, learning GRTR agents, and storing, in a GRTR-specific memory, parameters of the learned GRTR agents. The method further includes, in a testing phase, generating a dependency tree for testing the text data, retrieving and evaluating the learned GRTR agents of the training phase to evaluate testing samples, making task-specific decisions for the testing samples, and reporting the task-specific decisions to a computing device operated by a user.

A non-transitory computer-readable storage medium comprising a computer-readable program is presented for implementing graph-based reinforced text representation learning (GRTR), wherein the computer-readable program when executed on a computer causes the computer to perform the steps of, in a training phase, generating a dependency tree for training text data, training a GRTR agent by learning to navigate in the dependency tree and selectively collecting semantic information, learning GRTR agents, and storing, in a GRTR-specific memory, parameters of the learned GRTR agents. The computer-readable program when executed on a computer causes the computer to perform the further steps of, in a testing phase, generating a dependency tree for testing the text data, retrieving and evaluating the learned GRTR agents of the training phase to evaluate testing samples, making task-specific decisions for the testing samples, and reporting the task-specific decisions to a computing device operated by a user.

A system for implementing graph-based reinforced text representation learning (GRTR) is presented. The system includes a memory and one or more processors in communication with the memory configured to, in a training phase, generate a dependency tree for training text data, train a GRTR agent by learning to navigate in the dependency tree and selectively collecting semantic information, learn GRTR agents, and store, in a GRTR-specific memory, parameters of the learned GRTR agents. The system is further configured to, in a testing phase, generate a dependency tree for testing the text data, retrieve and evaluate the learned GRTR agents of the training phase to evaluate testing samples, make task-specific decisions for the testing samples, and report the task-specific decisions to a computing device operated by a user.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an exemplary procedure of graph-based reinforced text representation learning (GRTR), in accordance with embodiments of the present invention;

FIG. 2 is a block/flow diagram of an exemplary procedure of generating dependency trees for training text data, in accordance with embodiments of the present invention;

FIG. 3 is a block/flow diagram of an exemplary sentiment analysis table, in accordance with embodiments of the present invention;

FIG. 4 is a block/flow diagram of an exemplary procedure for training a GRTR agent, in accordance with embodiments of the present invention;

FIG. 5 is a block/flow diagram of an exemplary framework for the GRTR, in accordance with embodiments of the present invention;

FIG. 6 is a block/flow diagram of an example practical application of the GRTR framework, in accordance with embodiments of the present invention;

FIG. 7 is block/flow diagram of an exemplary processing system for the GRTR framework, in accordance with embodiments of the present invention; and

FIG. 8 is a block/flow diagram of an exemplary method for implementing the GRTR framework, in accordance with embodiments of the present invention.

### DETAILED DESCRIPTION OF PREFERRED EMBODIMENTS

The purpose of aspect-based sentiment classification is to predict the sentiment polarities of a corresponding aspect. For instance, give a sentence “I like this computer but do not like the screen,” the sentiment of “computer” is positive while the sentiment for “screen” is negative. It is a challenging task since the model should be able to correctly link the aspect with the sentiment descriptions.

Several methods have been implemented for aspect-sentiment prediction. Conventional deep neural networks are designed to aggregate sentiment features and obtain more distinctive representations for sentiment classification. The latent relations between different words are important for semantic analysis. Thus, attention-based methods associated with Recurrent Neural Networks (RNNs) are widely utilized in general natural language processing tasks such as translation. Moreover, in a sentence, the distance between aspect and sentiment could be far in a sentence, and thus it is difficult for attention-based approaches to accurately recognize the relations. However, the long distance in the sentence could be correlated in a syntactical aspect. Certain conventional art imposed syntactical constraints on attention weights, but the effect of syntactical structure was not fully exploited. Another conventional art utilized the sentence dependency graph as prior knowledge for the final task. By this way, the syntactical knowledge is involved which could further improve the performance. A syntactical dependency graph associated with the attention mechanism effectively improves the final learning performance. However, the capacity of the attention model is still limited in linking the corresponding aspects and sentiments together. This drawback reduces the potential effectiveness of the syntactical knowledge in sentiment analysis.

Reinforcement learning is a promising approach which automatically and actively explores the environment and achieves the optimized strategy for the final goal. There are two directions (e.g., Deep QNetworks and Policy Networks) for general implementation strategies. They are deployed in several natural language processing tasks including dialog generation, semi-supervised text classification, coreference, knowledge graph reasoning, text games, social media, information extraction, language and vision.

The exemplary embodiments introduce an aspect-based sentiment classification method via reinforcement learning. Syntactical knowledge is first utilized to generate the dependency graph of the target sentence. Thus, the related aspect-sentiment pairs could be close. A policy-based agent with continuous states is introduced to find the most correlated path starting from the aspect node. A long short-term memory (LSTM) network is designed to aggregate the semantic and sequential information in the path. The obtained representation is set as the state input for policy network as well as the feature input for final sentiment classification.

The exemplary embodiments deploy a reinforcement learning strategy for aspect-based sentiment classification tasks. The exemplary embodiments accurately pinpoint the most related sentiment description for each target aspect. The dependency graph of the source sentence is generated, which fully explores the syntactical knowledge residing inside the sentence.

The exemplary embodiments introduce an aspect-based sentiment classification framework. First, a semantic dependency tree is extracted from a given sentence. By this way, the sophisticated syntactical structure of the sentences could be arranged. Second, a reinforcement learning strategy is deployed with a specifically designed state, action, and reword for the final sentiment classification task. Reinforcement learning could effectively and accurately pinpoint the most relevant sentiment description based on the obtained dependency graph. The exemplary embodiments first introduce the preliminary details of aspect-based sentiment classification. Then, the details of the three reinforcement learning components, state, action, and reward, are introduced.

Given a sentence or description c={w₁^{c}, w₂^{c}, w₃^{c}, . . . wₙ^{c}} where wᵢ^{c}, represents the i-th word in each instance, n is the total number of the words. The target aspect of c is given as a_{c}={wᵣ₊₁^{c}, . . . wᵣ₊ₘ^{c}}, where r indicates the start location of the aspect in c and m is a length of the aspect. The aspect could be either a single-word format (e.g., computer, service, and screen) or multi-word format (e.g., HDMI port, and sport mode). There could be multiple aspects in an instance, and the goal of aspect-based sentiment classification is to predict sentiment polarities (e.g., positive, neutral, and negative) for each aspect. The sentiment of the aspects could be different or even totally opposite.

Regarding dependency graph extraction, a dependency graph Gc∈ [symbol] ^{n×n} is extracted from c. The nodes in Gc are the connection categories which include the syntactical relation of each pair of words. No edges exist if there are no syntactical connections between the two words. By deploying dependency tree, the exemplary embodiments transfer the conventional natural language processing problem to a graph learning problem. There are several advantages of this strategy. First, the word distances are converted from the sentence distance to the graph distances based on the syntactical knowledge. In this scenario, the related long-distance pair of words could be close in the dependency tree. This makes the correlation exploration approach easier to pinpoint the corresponding sentiment words. Second, the edges in the dependency graph provides correlation categories (e.g., IP, NP, VP). The exemplary embodiments consider this as the extra informative knowledge which could be further utilized to boost the classification performance.

Regarding reinforcement learning sentiment search, conventional sentiment analysis approaches usually deploy graph processing algorithms (e.g., graph representation learning, feature aggregation, and attention mechanism) to process the obtained dependency graph. However, in sentiment analysis data, a correct prediction is usually based on the most correlated clue. The clue is usually a single word or a short description which includes only a few words. Most of these approaches globally consider the sentiment descriptions which are easily affected by the noise and irrelevant nodes around the aspect node. Moreover, the graph-based approach usually cannot fully explore the relation/edge categories.

The exemplary embodiments design a reinforcement learning framework to explore the most related aspect-sentiment correlations in the obtained graph. Specifically, an agent which is initialized in the target aspect node, selects the next node to move based on the current state. After the agent finishes a move, the state will be updated. When sufficient sentiment information is collected, the agent will stop the walk automatically. A classifier will finally predict the sentiment categories based on the walk path. There are three components in the reinforcement model, that is, test comprehension which reflects the comprehensive state as input to the agent to make action, an actor, which makes the decision for which node to walk in the next move or stop the move, and a classifier, which obtains the final prediction of the sentiment categories.

Regarding text comprehension, text comprehension aims to provide comprehensive state information as an input to an agent. There are several requirements that need to be satisfied.

First, the state should make the procedure as a Markov Decision Process (MDP), where the expression is shown below:

P(Sₜ₊₁,Rₜ₊₁|S₀,A₀,R₁, . . . Sₜ,Aₜ)=P(Sₜ₊₁,Rₜ₊₁|Sₜ,Rₜ)

where Sₜ₊₁ and Rₜ₊₁ are the state and reward after the action Aₜ. Generally speaking, the potential reward of the next action is only relevant to a current state and action, while is irrelevant to neither history states or actions. However, in the sentiment analysis task, the searching path including the sequential information of the path provides important clues. Thus, the current state Sₜ is required to preserve all the information for the agent for the next action.

To achieve this goal, the exemplary embodiments deploy the simple while effective recurrent neural network (RNN) structure to update the state. The function is shown below:

Sₜ^{p}=ƒ(UMₜ+WSₜ₋₁^{p})

where Sₜ₋₁^{p} is the previous path state, which preserves the sequential path information and is updated at each step. Mt is the current input, which is obtained based on the action At, ƒ (⋅) is a multi-layer network which merges both previous state and current input together. S₁=ƒ (W S₀) is the representation of the first step where S₀=w₀ is the embedding of the aspect node.

Second, the agent should also perceive the comprehensive candidate moves simultaneously for the path/action selection. However, conventional reinforcement learning tasks usually have consistent data structure and size (e.g., images, videos, and sensor signals). However, in the dependency graph, each node could have a different number of neighbor nodes associated with various connection categories. The exemplary embodiments thus introduce a structural input mechanism which pre-arranges the candidate path based on the connection categories, and the exemplary embodiments set a zero input when there are no connections in the graph.

The expression of the input is formulated as shown below:

Sₜ^{c}=cat(pₗ,pₘ,pᵣ)

where cat(⋅) indicates the concatenation operation, and pₗ, pₘ, and pᵣ denote the left, middle, and right nodes in the dependency tree, respectively. This input mechanism relaxes the input inconsistency while still preserving the local structural information of the dependency tree.

Both Sₜ^{p} and Sₜ^{c} are important for the agent to decide the action. Thus, in the exemplary model, the exemplary embodiments concatenate them together as the agent input.

Regarding the actor, the input of the actor is the combination of the state Sₜ^{p} where a previous path history is preserved and the state Sₜ^{c} where the candidate path is provided. The goal of the actor is to find reliable predictive paths between aspect nodes and sentiment description in the obtained dependency tree. The action a is the walk started from the aspect node. The state is the visited nodes. In the exemplary model, the actor is a policy network with Sₜ^{p} and Sₜ^{c} being concatenated together Sₜ^{s}=[Sₜ^{p}, Sₜ^{c}], as the input. However, as previously mentioned, in the dependency graph, the node could have a different number of neighbor nodes with various connection categories. Thus, it is challenging to define a consistent action space which covers all the candidate paths in the same output.

In the model, the exemplary embodiments introduce a random selecting strategy to handle this issue. The output of the policy network is a vector, where each element of the vector corresponds to a word category in the dependency tree. Usually, there is only one or no words matching the element. In this scenario, the specifically designed reword function would guide the policy network. However, if multiple path candidates share the same category, the exemplary approach would randomly select a path for walk. Moreover, the actor could also output a stop action when enough sentiment information is collected from the path. In the implementation, the exemplary embodiments use a fully-connected neural network to parameterize the policy function that maps the state vector Sₜ^{s} to a probability distribution over all possible actions. The neural network includes two hidden layers, each followed by a rectifier nonlinearity layer (ReLU). The output layer is normalized using a softmax function.

Several factors directly influence the quality of the correlation prediction. To encourage the agent to find the most correlated paths, the stop process for the final classification is triggered. The reward mechanism is specifically designed to let the agent perform well in each stage.

Regarding classification accuracy, sentiment classification accuracy is the final goal of the model. To this end, the correct prediction should have the highest reward and vice versa. The accuracy reward function is shown below:

$${r}_{acc} = \{ \begin{matrix}{λ}_{1} , correct \\ - {λ}_{1} , incorrect\end{matrix}$$

where r_{acc} is the accuracy reward. λ₁ is the reward trade-off parameter and the exemplary embodiments set λ₁=100 in the exemplary implementation. The parameter sensitivity analysis will be provided in the experiments. r_{acc} would only be calculated once after the actor stops the walk and the prediction result is obtained.

Regarding path length, dependency analysis aligns the syntactical word to be close. Due to this reason, the exemplary approach assumes that the most correlated sentiment descriptions and clues should also be found/searched in the close or short distance regions in the dependency graph. In addition, shorter walk paths can also improve the efficiency of the searching procedure and reduce the negative influence of the noise from other sentimental descriptions. To achieve this goal, the exemplary embodiments design a straightforward and effective reward function which is shown below:

$${r}_{len} = \{ \begin{matrix}- 1 , & keep walking \\ 0 , & stop\end{matrix}$$

where rₗₑₙ indicates the walking length reward. In the reward function, each walk will get a negative reward until the actor stops. The exemplary embodiments directly set negative reward as −1 and the trade-off parameter λ₁ in the r_{acc} equation would balance the weights.

Regarding path variation,

$${r}_{var} = - \frac{1}{n} {\sum }_{1}^{n} ‖ {P}_{0} - {P}_{i} ‖ \frac{2}{F}$$

The relations in a semantic dependency tree are naturally discrete atomic symbols, while the nodes are continuous. Since there could be new/unseen words in the testing stage, it is desired that the model is still capable of handling such scenario. It is expected that the agent finds the most informative paths linking these node pairs. The following components are beneficial and necessary to set a state for reinforcement learning, that is, the aspect node which is also the starting point of the agent, the visited path of the agent associated with the information in the path, and the candidate moves for the next step.

The goal of the exemplary approach is predicting the sentiment polarities of the corresponding aspect. To this end, after each walk is finished by the actor, the updated state Sₜ^{p} is also obtained via the recurrent network. In the model, the exemplary embodiments consider Sₜ^{p} has already contained the comprehensive sequential information of the path. After the Sₜ^{p} is updated by the last action Mt, the exemplary embodiments directly forward Sₜ^{p} into a classifier for the final sentiment classification. The expression are shown below:

p=δ(WₚSₜ^{p}+bₚ)

where δ(⋅) is the non-liner activation. In the implementation, the exemplary embodiments deploy softmax activation to predict one polarity from the candidate pool. wₚ represents the weights and bₚ represents the bias.

In summary, the exemplary embodiments introduce an aspect-based sentiment classification approach via reinforcement learning. The syntactical knowledge is involved by building the dependency knowledge of the sentence, which effectively connects related words close in the graph. Then, a reinforcement learning strategy is deployed to further explore the path with the most related sentiment clues in the graph. The sentiment features are forwarded to a classifier for final classification. All the networks are simultaneously trained in an end-to-end scenario.

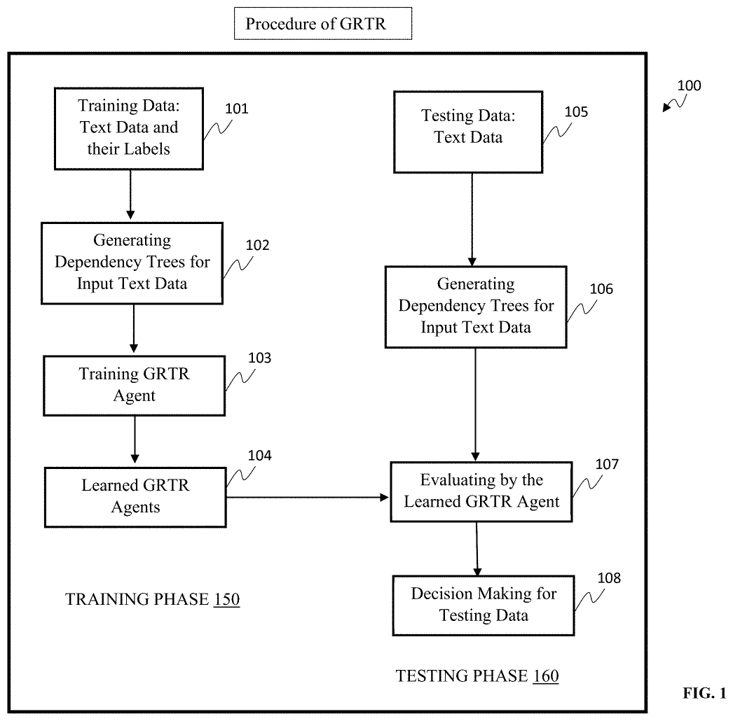

FIG. 1 is a block/flow diagram 100 of an exemplary procedure of graph-based reinforced text representation learning (GRTR), in accordance with embodiments of the present invention.

Unlike existing methods that process text data following its natural order, the exemplary embodiments utilize the domain knowledge from natural language processing, and introduce structures (e.g., dependency trees) among words into the learning process. Such structure information from domain knowledge can effectively provide discriminative features that improve decision-making quality.

Unlike existing methods that learn to aggregate all input text data, the exemplary method learns to navigate in dependency trees, selectively collect information, and stop the navigation when collected information is sufficient to make decisions. In other words, the exemplary method also learns how to ignore task-irrelevant text input data. By effectively excluding noise from task-irrelevant data, the exemplary method can improve decision-making quality.

Regarding block 101, training data: text data and their labels, the exemplary embodiments can represent the training data as a collection of samples and sample labels {(x, y)}. In the case of sentiment analysis, x could be a user's review for a specific product, and y could be the sentiment/polarity behind the review x.

Regarding block 102, generating dependency trees for training text data, for each sample x in training data, the exemplary embodiments generate its dependency tree using existing tools. In this way, the exemplary embodiments introduce structures that connect words/tokens in x via domain knowledge from natural language processing.

Regarding block 103, training the GRTR agent, the exemplary embodiments train an agent that makes a sequence of decisions to explore the dependency trees from block 102, collect necessary information with minimal effort, and make classification/prediction decisions eventually.

Regarding block 104, learned GRTR agents, when a GRTR agent is learned, the exemplary embodiments store its parameters. The learned parameters will be retrieved, when the exemplary embodiments need to make prediction/classification for unseen testing data.

Regarding block 105, testing data: text data, each sample x′ could be unseen compared with the training data used to learn the agent.

Regarding block 106, generating dependency trees for testing text data, as performed in block 102, the exemplary embodiments generate a dependency tree for each sample x′ in testing.

At block 107, evaluating by the learned GRTR agent, the exemplary embodiments retrieve the learned agent and let the agent evaluate testing samples.

At block 108, decision making for testing data, after the agent reaches a decision for an input testing sample, the decision will be reported to end users.

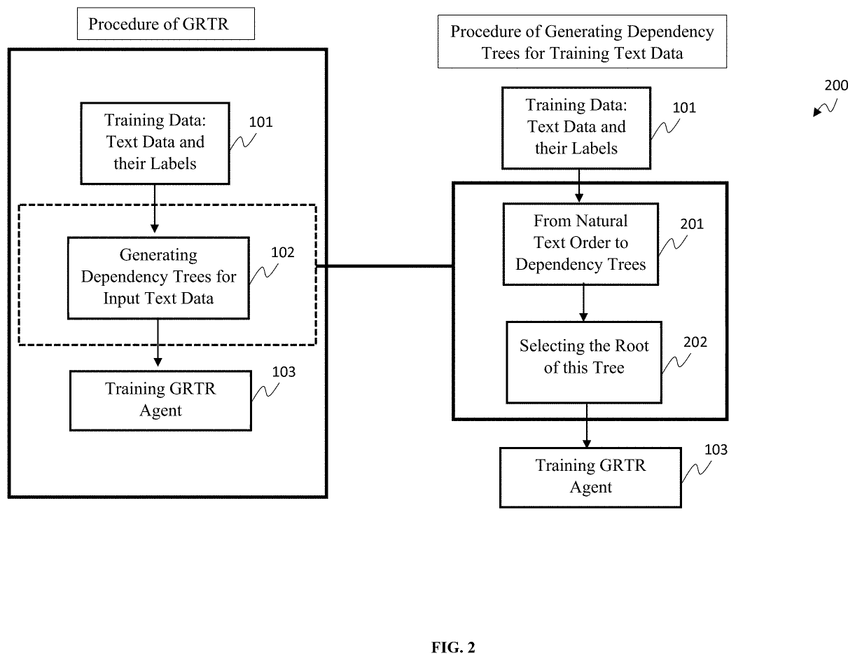

FIG. 2 is a block/flow diagram 200 of an exemplary procedure of generating dependency trees for training text data, in accordance with embodiments of the present invention.

Regarding block 201, from natural text order to dependency trees, for each input sample x, the exemplary embodiments use existing tools from natural language processing to generate its dependency tree.

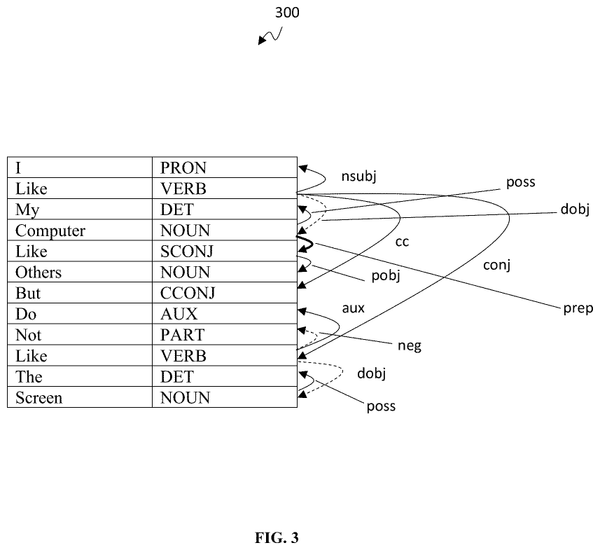

Regarding block 202, selecting the root of this tree, the root of a dependency will be the starting word for an agent to explore in block 103. The selection of the root is task-dependent. In the example shown in FIG. 3 below, if the task is to evaluate the sentiment for “screen,” then the root of this tree is the word “screen.”

The output of 202 is a dependency tree where an agent can start exploration from its root.

FIG. 3 is a block/flow diagram 300 of an exemplary sentiment analysis table, in accordance with embodiments of the present invention.

In this example, the exemplary embodiments are dealing with input text “I like my computer like others but do not like the screen”. The arcs between words are edges introduced by its dependency tree, and the attributes on arcs indicate the relationship between words in this tree.

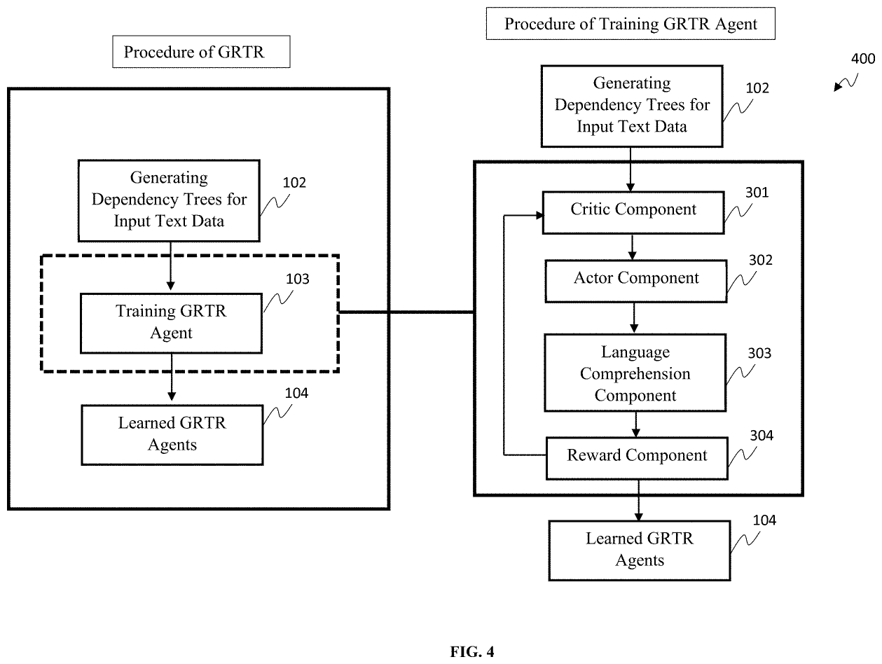

FIG. 4 is a block/flow diagram 400 of an exemplary procedure for training a GRTR agent, in accordance with embodiments of the present invention.

FIG. 4 illustrates the detailed procedure of training GRTR agent. Starting from the root of a dependency tree with an initial state represented by a vector s₀, an agent makes a sequence of decisions by the following component.

Regarding block 301, the critic component, suppose the agent is at word wᵢ with state sᵢ. Now the agent needs to make the following actions: visit one of the neighbor words from the dependency tree or stop exploration and make classification/prediction using collected information. For a specific action a, the critic component V(sᵢ, a; θ_{c}) aims to estimate the value brought by action a given state sᵢ, where a critic component could be implemented by a multi-layer neural network and θ_{c} is the parameters in the network.

Regarding block 302, the actor component, suppose the agent is at word wᵢ with state sᵢ. Based on the value estimation from critic component, this component aims to estimate P(a|sᵢ, V(sᵢ, a; θ_{c}); θₐ), that is, given current state sᵢ and value estimation for (sᵢ, a), the probability of an agent will take action a, where the estimation function could be implemented by a multi-layer neural network and θₐ are the parameters in this component

Regarding block 303, the language comprehension component, suppose the agent is at word wᵢ with state sᵢ. By the actor component, the agent decides to visit wᵢ₊₁ next. The state sᵢ₊₁ is evaluated by a function sᵢ₊₁=f(sᵢ, wᵢ₊₁; θ_{f}), where function f( ) could be implemented by a recurrent neural network and θ_{f} is the parameters in this network.

Regarding block 304, the reward component, suppose the agent is at word wₜ with state sₜ. By the actor component, the agent decides to stop. Next, the agent evaluates the reward from sₜ by using sₜ as the input for the downstream classification/prediction task. The prediction quality is evaluated by Q(sₜ), and the whole reward is evaluated as R(sₜ)=d^{t} Q(sₜ), where d is a discount factor (0<d<1) that encourages to obtain more rewards using minimal effort.

With the goal of maximizing R(sₜ), using stochastic gradient descent, the exemplary embodiments can iteratively optimize and update parameters θ_{c}, θ_{f}, and θₐ. The learned parameters can be stored in block 104.

For block 106, it is similar to block 102, following two steps, to generate dependency trees and roots for input testing samples.

For block 107, the exemplary embodiments follow blocks 301-304. Using the learned parameters, the agent makes a sequence of actions to reach a decision for an input testing sample.

Thus, the exemplary embodiments introduce a graph-based reinforced text representation learning (GRTR). The exemplary method includes a training phase 150 and a testing phase 160, as illustrated collectively in FIGS. 1-4.

In the training phase, leveraging labeled text data and their labels, the exemplary method first transforms input text into its dependency tree by existing tools, learns how to navigate in this dependency tree and collects necessary semantic information, and finally makes task-specific decisions that maximize accuracy.

In the testing phase, dealing with unseen text data, the exemplary method first transforms input text into its dependency tree as done in the training phase. The learned model then navigates in the dependency tree and collects semantic information. Finally, the learned model makes a prediction/classification decision for the input text data.

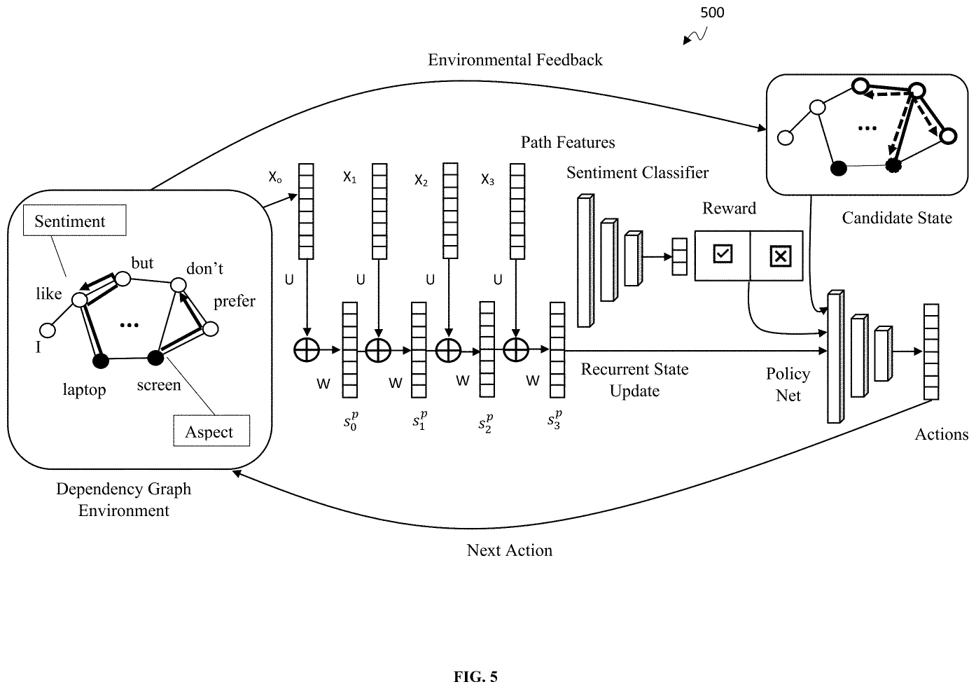

FIG. 5 is a block/flow diagram 500 of an exemplary framework for the GRTR, in accordance with embodiments of the present invention.

A dependency graph is first obtained, which involves syntactical knowledge in the learning procedure. The related sentiment clues could be closer in dependency tree compared with the original sentence space. An agent starts from an aspect node.

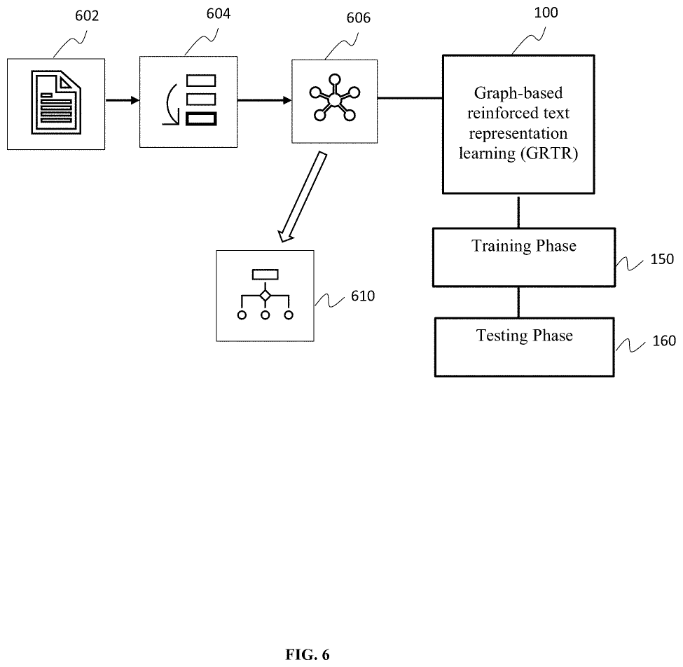

FIG. 6 is a block/flow diagram of an example practical application of the framework for the GRTR, in accordance with embodiments of the present invention.

In one practical application, a document 602 is provided where dependency trees 604 are extracted therefrom and provided to a network 606, which employs the graph-based reinforced text representation learning (GRTR) 100 of the exemplary embodiments of the present invention. The graph-based reinforced text representation learning (GRTR) 100 can execute the steps of the training phase 150 and the steps of the testing phase 160. Decisions 610 for the testing data are made based on the analysis.

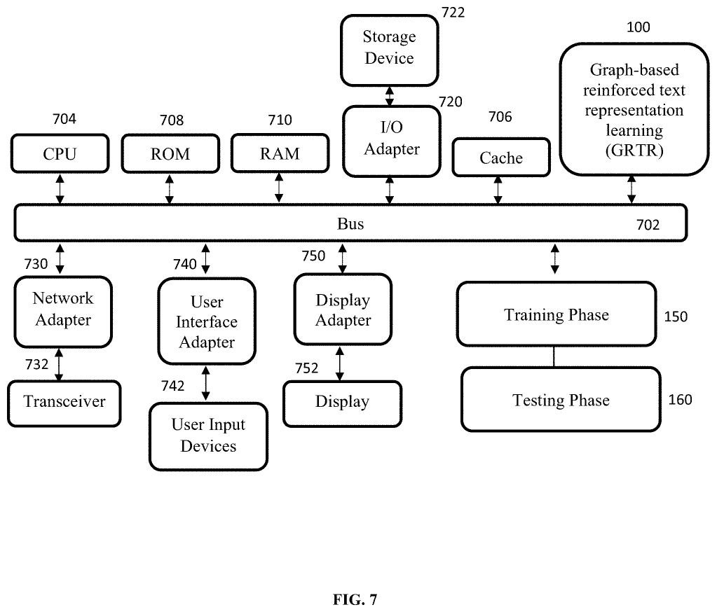

FIG. 7 is block/flow diagram of an exemplary processing system for the GRTR framework, in accordance with embodiments of the present invention.

The processing system includes at least one processor or processor device (CPU) 704 operatively coupled to other components via a system bus 702. A cache 706, a Read Only Memory (ROM) 708, a Random Access Memory (RAM) 710, an input/output (I/O) adapter 720, a network adapter 730, a user interface adapter 740, and a display adapter 750, are operatively coupled to the system bus 702. The graph-based reinforced text representation learning (GRTR) 100 can be connected to bus 702. The graph-based reinforced text representation learning (GRTR) 100 implements the training phase 150 and the testing phase 160.

A storage device 722 is operatively coupled to system bus 702 by the I/O adapter 720. The storage device 722 can be any of a disk storage device (e.g., a magnetic or optical disk storage device), a solid state magnetic device, and so forth.

A transceiver 732 is operatively coupled to system bus 702 by network adapter 730.

User input devices 742 are operatively coupled to system bus 702 by user interface adapter 740. The user input devices 742 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 742 can be the same type of user input device or different types of user input devices. The user input devices 742 are used to input and output information to and from the processing system.

A display device 752 is operatively coupled to system bus 702 by display adapter 750.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, processor devices, controllers, memories, and so forth, in various configurations can also be utilized as readily appreciated by one of ordinary skill in the art. These and other variations of the processing system are readily contemplated by one of ordinary skill in the art given the teachings of the present invention provided herein.

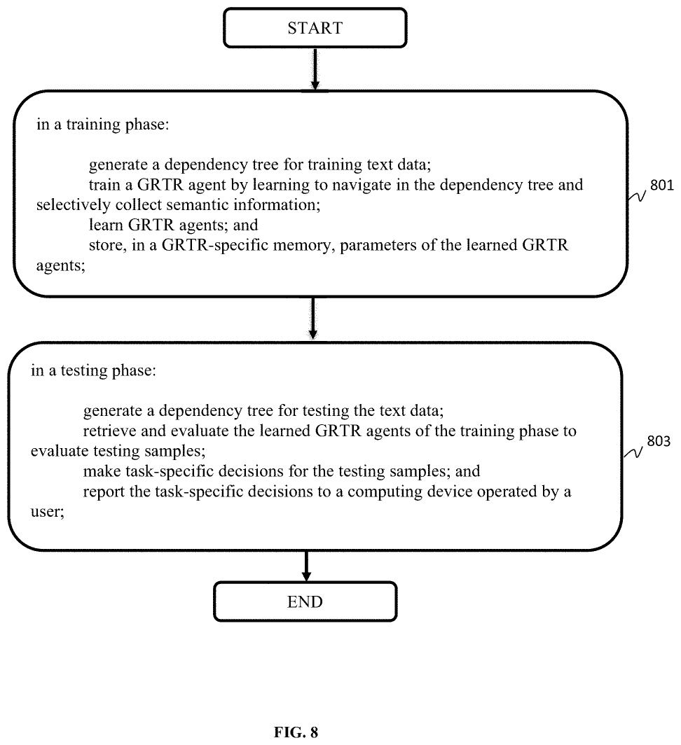

FIG. 8 is a block/flow diagram of an exemplary method for implementing the GRTR framework, in accordance with embodiments of the present invention.

At block 801, in a training phase, generate a dependency tree for training text data, train a GRTR agent by learning to navigate in the dependency tree and selectively collect semantic information, learn GRTR agents, and store, in a GRTR-specific memory, parameters of the learned GRTR agents.

At block 803, in a testing phase, generate a dependency tree for testing the text data, retrieve and evaluate the learned GRTR agents of the training phase to evaluate testing samples, make task-specific decisions for the testing samples, and report the task-specific decisions to a computing device operated by a user.

Therefore, the exemplary embodiments introduce a reinforcement learning framework for aspect-based sentiment classification. The dependency tree of a given sentence is obtained, which includes basic syntactical information and word dependencies. A policy-based agent with continuous states is introduced to find the most correlated path starting from the aspect node. An LSTM network is provided to aggregate the semantic and sequential information in the path. The obtained representation is set as the state input for the policy network, as well as the feature input for final sentiment classification.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method executed on a processor for implementing graph-based reinforced text representation learning (GRTR), the method comprising:
in a training phase:
generating a dependency tree for training text data;
training a GRTR agent by learning to navigate in the dependency tree and selectively collecting semantic information;
learning GRTR agents; and
storing, in a GRTR-specific memory, parameters of the learned GRTR agents; and
in a testing phase:
generating a dependency tree for testing the text data;
retrieving and evaluating the learned GRTR agents of the training phase to evaluate testing samples;
making task-specific decisions for the testing samples; and
reporting the task-specific decisions to a computing device operated by a user.

2. The method of claim 1, wherein, for the training of the GRTR agent, starting from a root of the dependency tree for training text data with an initial state represented by a vector, an agent makes a sequence of decisions.

3. The method of claim 2, wherein the sequence of decisions is made by employing a critic component, an actor component, a language comprehension component, and a reward component.

4. The method of claim 3, wherein the critic component estimates a value by an action given a specific state, the critic component implemented by a multi-layer neural network.

5. The method of claim 3, wherein the actor component estimates a probability the agent takes an action, the actor component implemented by a multi-layer neural network.

6. The method of claim 1, wherein the language comprehension component is implemented by a recurrent neural network.

7. The method of claim 1, wherein task-irrelevant input data is ignored to improve task-specific decision quality.

8. A non-transitory computer-readable storage medium comprising a computer-readable program for implementing graph-based reinforced text representation learning (GRTR), wherein the computer-readable program when executed on a computer causes the computer to perform the steps of:
in a training phase:
generating a dependency tree for training text data;
training a GRTR agent by learning to navigate in the dependency tree and selectively collecting semantic information;
learning GRTR agents; and
storing, in a GRTR-specific memory, parameters of the learned GRTR agents; and
in a testing phase:
generating a dependency tree for testing the text data;
retrieving and evaluating the learned GRTR agents of the training phase to evaluate testing samples;
making task-specific decisions for the testing samples; and
reporting the task-specific decisions to a computing device operated by a user.

9. The non-transitory computer-readable storage medium of claim 8, wherein, for the training of the GRTR agent, starting from a root of the dependency tree for training text data with an initial state represented by a vector, an agent makes a sequence of decisions.

10. The non-transitory computer-readable storage medium of claim 9, wherein the sequence of decisions is made by employing a critic component, an actor component, a language comprehension component, and a reward component.

11. The non-transitory computer-readable storage medium of claim 10, wherein the critic component estimates a value by an action given a specific state, the critic component implemented by a multi-layer neural network.

12. The non-transitory computer-readable storage medium of claim 10, wherein the actor component estimates a probability the agent takes an action, the actor component implemented by a multi-layer neural network.

13. The non-transitory computer-readable storage medium of claim 8, wherein the language comprehension component is implemented by a recurrent neural network.

14. The non-transitory computer-readable storage medium of claim 8, wherein task-irrelevant input data is ignored to improve task-specific decision quality.

15. A system for implementing graph-based reinforced text representation learning (GRTR), the system comprising:
a memory; and
one or more processors in communication with the memory configured to:
in a training phase:
generate a dependency tree for training text data;
train a GRTR agent by learning to navigate in the dependency tree and selectively collect semantic information;
learn GRTR agents; and
store, in a GRTR-specific memory, parameters of the learned GRTR agents; and
in a testing phase:
generate a dependency tree for testing the text data;
retrieve and evaluate the learned GRTR agents of the training phase to evaluate testing samples;
make task-specific decisions for the testing samples; and
report the task-specific decisions to a computing device operated by a user.

16. The system of claim 15, wherein, for the training of the GRTR agent, starting from a root of the dependency tree for training text data with an initial state represented by a vector, an agent makes a sequence of decisions.

17. The system of claim 16, wherein the sequence of decisions is made by employing a critic component, an actor component, a language comprehension component, and a reward component.

18. The system of claim 17, wherein the critic component estimates a value by an action given a specific state, the critic component implemented by a multi-layer neural network.

19. The system of claim 17, wherein the actor component estimates a probability the agent takes an action, the actor component implemented by a multi-layer neural network.

20. The system of claim 15, wherein the language comprehension component is implemented by a recurrent neural network.
